(19) United States
(12) Patent Application Publication
(10) Pub. No.: US 2014/0353130 A1
(43) Pub. Date: Dec. 4, 2014

(54) ELECTRICAL CIRCUIT SWITCHING DEVICE

(71) Applicant: FANUC Corporation, Yamanashi (JP)

(72) Inventor: Yuuta SEKIKAWA, Yamanashi (JP)

(73) Assignee: FANUC Corporation, Yamanashi (JP)

(21) Appl. No.: 14/277,017

(22) Filed: May 13, 2014

(30) Foreign Application Priority Data
May 29, 2013 (JP) 2013-113236

(51) Int. Cl. H01H 9/22

(52) U.S. Cl. CPC H01H 9/22; H01H 2221/052
USPC 200/50.03

(57) ABSTRACT

An electrical circuit switching device includes a housing body including therein a circuit breaker for breaking/energizing an electrical circuit, and a housing door including a handle for operating the circuit breaker. A switch operating unit for driving a circuit switching unit of the circuit breaker includes a lock that can engage/disengage with/from a coupling part of the handle. The coupling part engages with the lock when the housing door is closed, and the circuit breaker can be operated only in this state via the coupling part.

### BACKGROUND OF THE INVENTION

1. Field of the Invention

The present invention relates to an electrical circuit switching device that is configured by a circuit breaker for energizing or breaking a power supply of devices installed in a housing of a switchboard, a control board or the like, and an external operating handle for operating the circuit breaker from the outside of the housing.

2. Description of the Related Art

Devices for energizing or breaking power supplies, which are configured by circuit breakers and external operating handles, are commonly known. Japanese Patent Application Laid-Open No. 2010-102898 discloses an external operating handle device for a circuit breaker that performs switching operation to the circuit breaker from the outside of a housing door and can regulate opening/closing of the housing door. Japanese Patent Application Laid-Open No. 2000-311538 discloses a power supply switching device including a mechanism in which a housing door cannot be opened until a power supply is turned off. In addition, Japanese Patent Application Laid-Open No. 2004-265843 discloses an external operating handle device which performs switching operation to a circuit breaker from the outside of a housing door and which can close the housing door even in a tripped state.

However, the aforementioned Japanese Patent Application Laid-Open No. 2010-102898 and Japanese Patent Application Laid-Open No. 2004-265843 describe that the circuit breaker alone can energize the power supply by directly operating a coupling part of the circuit breaker, but have no description of restriction for energizing or breaking the power supply by the circuit breaker alone. Furthermore, the aforementioned Japanese Patent Application Laid-Open No. 2000-311538 has no mention of restriction for energizing or breaking the power supply by the circuit breaker alone.

As described above, with the conventional circuit breakers and the external operating handles, the circuit breaker alone can energize the power supply in the state where the housing door is opened. Alternately, the power supply can be easily energized by operating an operating part that is included in the circuit breaker and can energize the power supply, by hand, or by operating a portion coupled with the external operating handle, by hand. In such a manner, if the power supply can be energized in the state where the housing door is opened, an operator is at risk of mistakenly touching energized parts of devices installed in the housing. In addition, if the devices continue operating while the housing door is opened, the devices are kept exposed to the open air, which can cause failure of the devices, affecting their reliability.

### SUMMARY OF THE INVENTION

The present invention thus has an object to provide an electrical circuit switching device that can energize a power supply only in the state where a housing door is closed, in order to ensure safety such that an operator does not touch energized parts of devices installed in a housing.

The electrical circuit switching device according to the present invention is installed inside the housing having a housing door, and includes a circuit breaker for breaking/energizing an electrical circuit, and an external operating handle, provided on the housing door, for operating the circuit breaker. The external operating handle includes an operating part and a coupling part for interlocking with the operating part. The circuit breaker includes a circuit switching unit for switching the electrical circuit to break/energize the electrical circuit, and a switch operating unit for driving the circuit switching unit. The switch operating unit further includes a lock part that can engage/disengage with/from the coupling part of the external operating handle, and is configured such that the coupling part of the external operating handle engages with the lock part of the switching operating unit when the housing door is closed, and meanwhile, such that the coupling part of the external operating handle disengages from the lock part of the switching operating unit when the housing door is opened. Thus the electrical circuit switching device is allowed to be operated via the coupling part of the external operating handle only in the state where the lock part of the switching operating unit is engaged with the coupling part of the external operating handle.

The lock part of the switching operating unit may be configured such that engagement of the coupling part of the external operating handle with the lock part is prevented in the state where the external operating handle is positioned at an energizing position, and disengagement of the coupling part of the external operating handle from the lock part is prevented in the state where the coupling part of the external operating handle engages with the lock part.

The present invention can provide an electrical circuit switching device that ensures safety such that an operator does not touch energized parts of devices installed in a housing, and can energize a power supply only in the state where a housing door is closed.

### BRIEF DESCRIPTION OF THE DRAWINGS

The aforementioned and other objects and features of the present invention will be apparent from the following description of embodiments given with reference to the accompanying drawings, in which:

FIG. 1 is a diagram illustrating one embodiment of an electrical circuit switching device according to the present invention;

FIG. 2 is a partially enlarged view of a circuit breaker and an external operating handle in FIG. 1;

FIG. 3 is an enlarged view of the circuit breaker of FIG. 1;

FIG. 4A and FIG. 4B are diagrams illustrating an OFF state (FIG. 4A) and an ON state (FIG. 4B) of the circuit breaker of FIG. 3;

FIG. 5 is a diagram illustrating the external operating handle of FIG. 2;

FIG. 6 is a diagram illustrating a coupling part in the external operating handle of FIG. 5;

FIG. 7 represents relation among the circuit breaker, a housing door, and the external operating handle illustrated in FIG. 2; and

FIG. 8 is a diagram illustrating a maintenance handle.

### DETAILED DESCRIPTION OF THE PREFERRED EMBODIMENTS

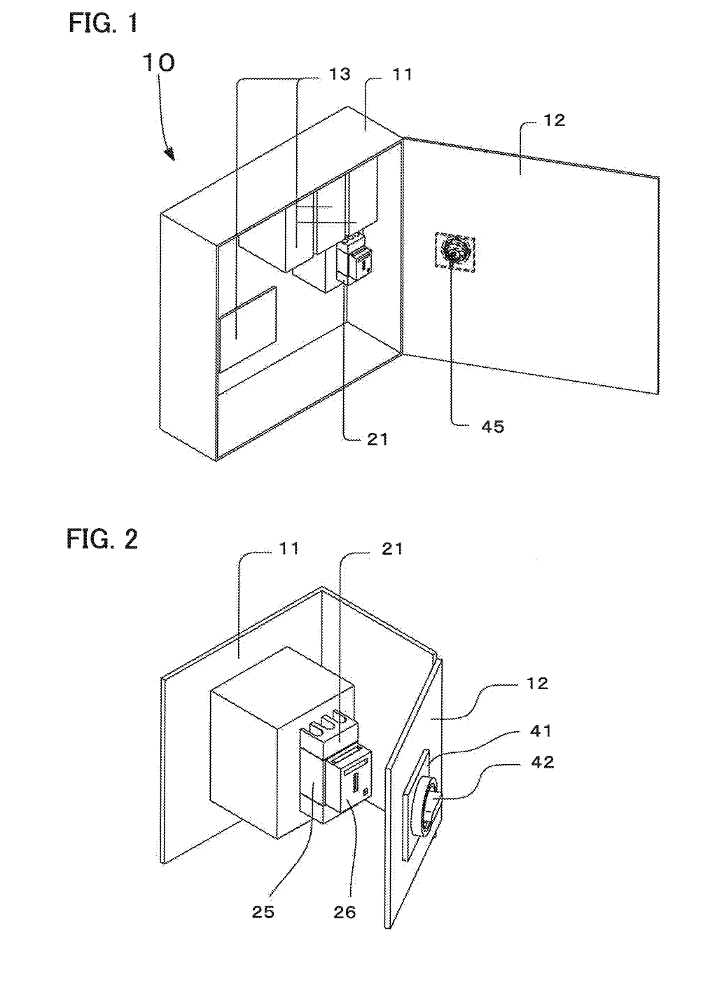

A housing 10 of an electrical circuit switching device for switchboard, a control board or the like includes, as illustrated in FIG. 1, a housing body 11 and a housing door 12, which can be opened and closed, for protecting the inside of the housing body 11 from the influence of the open air. To the housing body 11, various devices 13 such as a power supplying device, and a circuit breaker 21 for energizing and breaking power to the devices 13, are attached. Meanwhile, to the housing door 12, an external operating handle 41 for switching between energizing and breaking the circuit breaker 21 is attached, as illustrated in FIG. 2.

To ensure the safety such that an operator does not touch energized parts (not illustrated) of the devices 13 installed inside the housing body 11 with his or her hand, the electrical circuit switching device needs to have a configuration in which a power supply can be energized only in the state where the housing door 12 is closed. In addition, with such a configuration, the housing door 12 is in a closed state while the power supply is energized, allowing the devices 13 inside the housing body 11 to be protected from the open air. One embodiment of the electrical circuit switching device according to the present invention includes the circuit breaker 21 installed inside the housing body 11 and the external operating handle 41 attached to the housing door 12, in order to ensure the safety such that the operator does not touch the energized parts of the devices 13 installed inside the housing body 11 with a hand thereof.

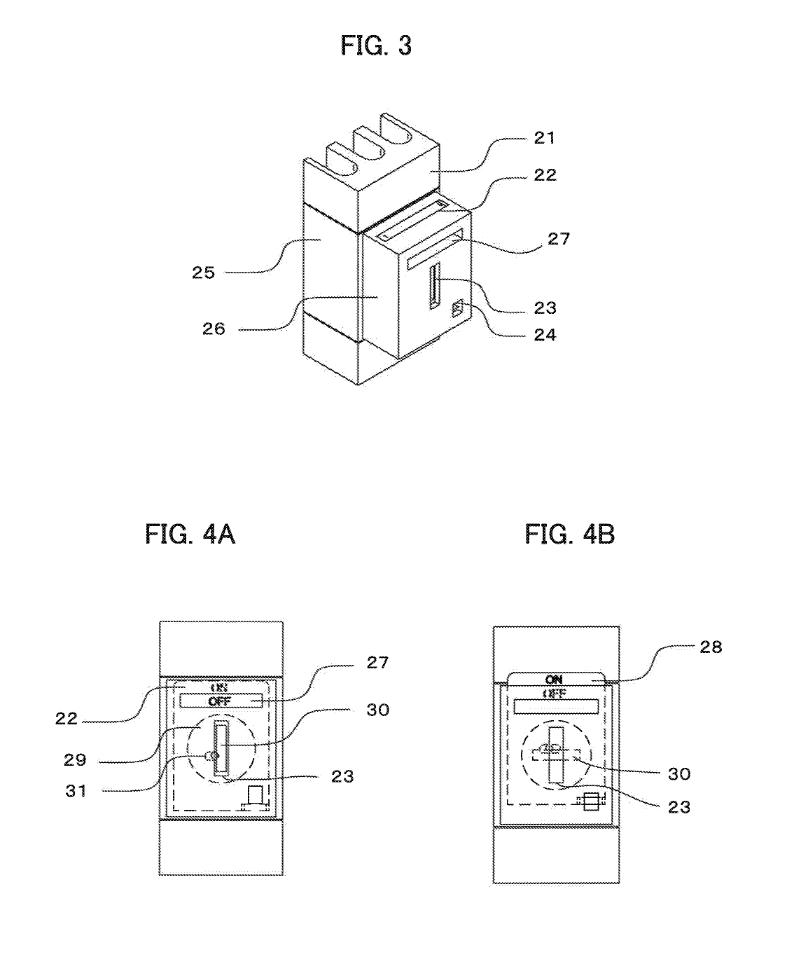

The circuit breaker 21 includes a circuit switching unit 25 for switching an electrical circuit, and a switch operating unit 26 for driving the circuit switching unit 25. By operating the switch operating unit 26 of the circuit breaker 21 with an operating part 42 (FIG. 2) of the external operating handle 41 to switch the circuit switching unit 25, the circuit breaker 21 is connected/interrupted to/from an external power supply. The switch operating unit 26 of the circuit breaker 21 includes a lock hole 23 and locking means 24, as illustrated in FIG. 3. Further, a lock base 29 and a switching operation base 22 are provided inside the switch operating unit 26.

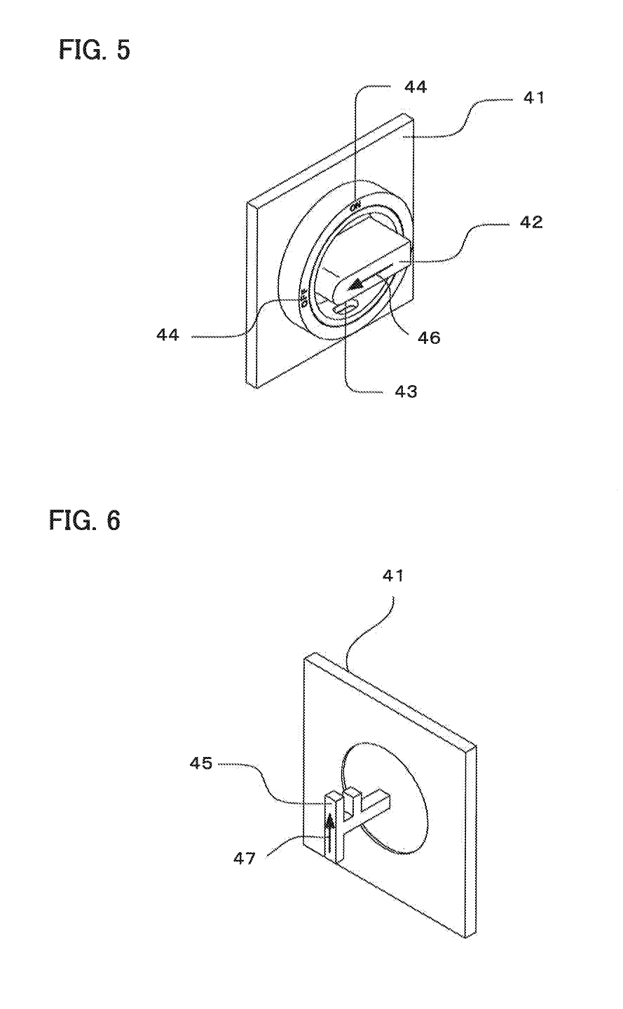

A direction of an arrow 46 of the operating part 42 is orthogonal to that of an arrow 47 of a coupling part 45, which causes the coupling part 45 of the external operating handle 41 to be turned in a direction illustrated by the arrow 47 of FIG. 6 when the operating part 42 of the external operating handle 41 is in the state of an OFF direction, as illustrated by the arrow 46 of FIG. 5. As a result, when the operating part 42 is in a state illustrated in FIG. 5, a lock (lock part) 30 attached to the lock base 29 is in engagement with the coupling part 45, as illustrated in FIG. 4A, bringing the circuit breaker 21 into the OFF state.

Meanwhile, when the operating part 42 illustrated in FIG. 5 is turned clockwise by 90 degrees to turn the arrow 46 in an ON direction, the circuit breaker 21 is brought into a state illustrated in FIG. 4B (the state where the lock 30 is detached from the coupling part 45), bringing the circuit breaker 21 into the ON state.

The external operating handle 41 includes the operating part 42 (FIG. 5) for switching the circuit breaker 21, the coupling part 45 (FIG. 6) coupled with the operating part 42, the locking means 43 to which a padlock (not illustrated) for locking the operations of the external operating handle 41 is attached, and a display part 44 for displaying whether the circuit breaker 21 is in the ON state or the OFF state.

The operating part 42 is, as illustrated in FIG. 5, a rotatable member and has a rectangular shape one side surface of which is curved. The locking means 43 is, as illustrated in FIG. 5, a hole formed at a predetermined position in an annular wall part provided around the operating part 42, and an arm part of the padlock is inserted into the hole (locking means 43). Note that the display part 44 is “ON” and “OFF” displays illustrated in FIG. 5 that are provided on the wall part with a sticker, an inscription or the like, and the operating part 42 of FIG. 5 points to “OFF” (in a horizontal direction). Turning clockwise the operating part 42 of FIG. 5 by 90 degrees makes the operating part 42 point to “ON” (in a vertical direction).

When the housing door 12 is closed, the lock hole 23 (FIG. 3) of the switch operating unit 26 provided on the circuit breaker 21 is coupled with the coupling part 45 (FIG. 6) of the external operating handle 41. When the operating part 42 of the external operating handle 41 is turned after the coupling, the lock base 29 (FIG. 4A) is also turned via the coupling part 45. The turn of the lock base 29 then causes the switching operation base 22 (FIG. 3) to move vertically by a cam 31 formed by a hole provided in the switching operation base 22 and a pin attached to the lock base 29. The vertical movement of the switching 111 base 22 drives the circuit switching unit 25 such that an upward operation of the switching operation base 22 energizes the power supply as illustrated in FIG. 4B, and such that a downward operation of the switching operation base 22 breaks the power supply as illustrated in FIG. 4A.

Only when the circuit breaker 21 is in a broken state, the coupling part 45 (FIG. 6) of the external operating handle 41 can engage with, or detach from, the lock 30 through the lock hole 23 of the switch operating unit 26, as illustrated in FIG. 4A, On the other hand, when the circuit breaker 21 is in the energized state, the coupling part 45 of the external operating handle 41 cannot engage with, or detach from, the lock 30 through the lock hole 23 of the switch operating unit 26, as illustrated in FIG. 4B. As a result, it is not possible to open the housing door 12 when the circuit breaker 21 is in an energized state.

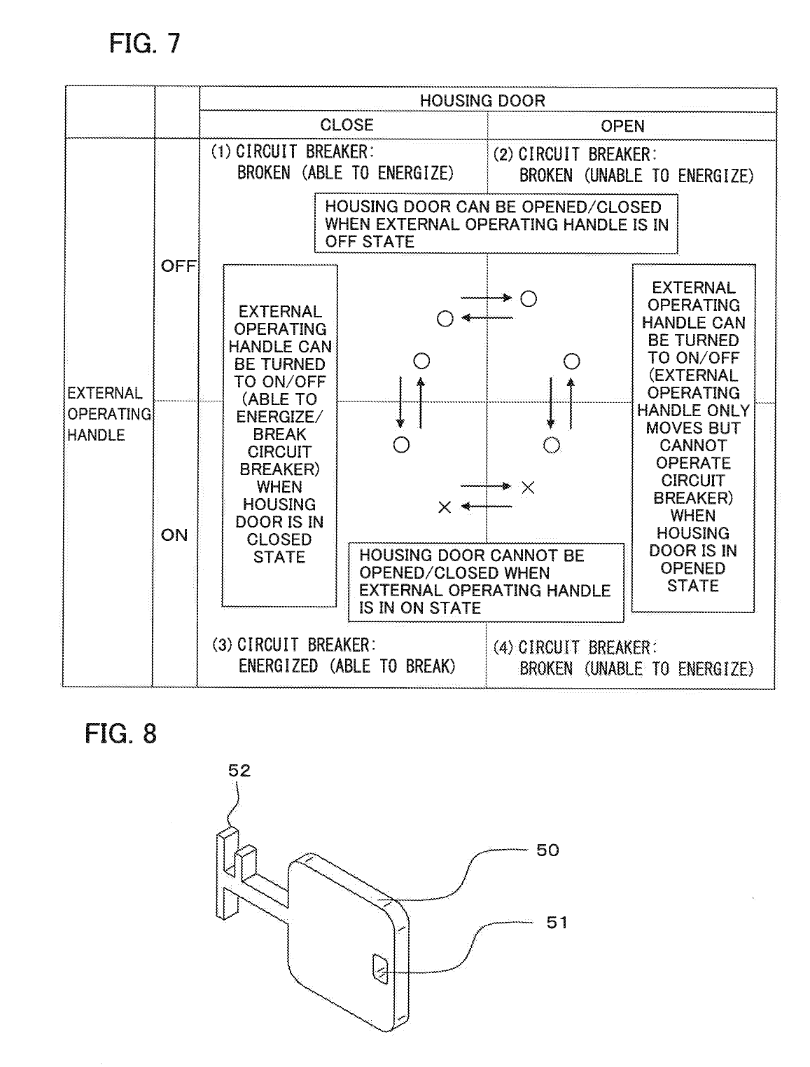

FIG. 7 illustrates relation among the circuit breaker 21, the housing door 12, and the external operating handle 41 illustrated in FIG. 2.
(1) When the external operating handle 41 is OFF and the housing door 12 is closed, the circuit breaker 21 is in the broken state and can be brought into the energized state.
(2) When the external operating handle 41 is OFF and the housing door 12 is opened, the circuit breaker 21 is in the broken state and cannot be brought into the energized state.
(3) When the external operating handle 41 is ON and the housing door 12 is closed, the circuit breaker 21 is in the energized state and can be brought into the broken state.
(4) When the external operating handle 41 is ON and the housing door 12 is opened, the circuit breaker 21 is in the broken state and cannot be brought into the energized state.

The circuit breaker 21 alone does not include means for energizing the power supply by human's hand or tools such as a screwdriver. To bring the circuit breaker 21 into the energized state, the coupling part 45 of the external operating handle 41 needs to be coupled with the lock hole 23 so as to operate the operating part 42. Thus, the power supply cannot be energized in the state where the housing door 12 is opened.

However, to maintain the devices 13 in the housing, there are cases where the devices 13 need to be energized with power in the state where the housing door 12 is opened. When the devices 13 in the housing are maintained, a maintenance handle 50 illustrated in FIG. 8 is used that includes a coupling part having the same shape as the coupling part 45 of the external operating handle, in order to energize the power supply as the housing door 12 is left opened. The maintenance handle 50 includes a string hole 51 into which a string is threaded to suspend the handle in a depository, and a maintenance coupling part 52 corresponding to the coupling part 45 (refer to FIG. 6).

The locking means 24 (FIG. 3) provided in the switch operating unit 26 of the circuit breaker 21 is used for preventing the power supply from being unintendedly energized in the maintenance operation in the case where the devices 13 installed inside the housing body 11 are maintained. Since the upward operation of the switching operation base 22 is restricted by locking the locking means 24 with a padlock (not illustrated), the power supply cannot be energized even with the maintenance handle 50. In addition, a display window 27 (FIG. 4A) is provided in the circuit breaker 21, allowing the state of the circuit breaker 21 to be checked even when the housing door 12 is opened, and a display part 28 (FIG. 4B) indicating ON and OFF is provided on an upper portion of the switching operation base 22. As the switching operation base 22 moves up and down, the display part 28 of ON or OFF is displayed in the display window 27. The circuit breaker alone does not include the means for energizing the power supply, but is provided with means for instantly breaking the power supply by moving down the switching operation base 22 protruding upward from the switch operating unit 26.

When a device (not illustrated) installed outside the housing 10 is maintained, the locking means 43 of the external operating handle 41 is used for preventing the power supply from being unintendedly energized in the maintenance operation. By locking the locking means 43 with a padlock (not illustrated), the power supply cannot be energized because the turning operation of the operating part 42 is thereby restricted. To allow an operator to check the state of the circuit breaker 21 outside the housing, the display part 44 of ON and OFF is provided on the annular wall part provided around the operating part 42 of the external operating handle 41.

What is claimed is:

1. An electrical circuit switching device installed inside a housing having a housing door, the electrical circuit switching device comprising:
a circuit breaker for breaking/energizing an electrical circuit; and
an external operating handle, provided on the housing door, for operating the circuit breaker, wherein
the external operating handle includes:
an operating part; and
a coupling part for interlocking with the operating part,
the circuit breaker includes:
a circuit switching unit for switching the electrical circuit to break/energize the electrical circuit; and
a switch operating unit for driving the circuit switching unit, and further
the switch operating unit includes
a lock part that can engage/disengage with/from the coupling part of the external operating handle, and is configured such that
the coupling part of the external operating handle engages with the lock part of the switching operating unit when the housing door is closed, and meanwhile,
the coupling part of the external operating handle disengages from the lock part of the switching operating unit when the housing door is opened, wherein
the electrical circuit switching device is allowed to be operated via the coupling part of the external operating handle only in the state where the lock part of the switching operating unit is engaged with the coupling part of the external operating handle.

2. The electrical circuit switching device according to claim 1, wherein the lock part of the switching operating unit is configured such that:
engagement of the coupling part of the external operating handle with the lock part is prevented in the state where the external operating handle is positioned at an energizing position, and
disengagement of the coupling part of the external operating handle from the lock part is prevented in the state where the coupling part of the external operating handle engages with the lock part.
